(19) United States
(12) Patent Application Publication
(10) Pub. No.: US 2026/0038244 A1
(43) Pub. Date: Feb. 5, 2026

(54) FEATURE EXTRACTION NETWORK TRAINING METHOD, CLASSIFICATION METHOD, APPARATUS, AND ELECTRONIC DEVICE

(71) Applicant: Tencent Technology (Shenzhen) Company Limited, Shenzhen (CN)

(72) Inventor: Lei SHEN, Shenzhen (CN)

(73) Assignee: Tencent Technology (Shenzhen) Company Limited, Shenzhen (CN)

(21) Appl. No.: 19/352,272

(22) Filed: Oct. 7, 2025

Related U.S. Application Data
(63) Continuation of application No. PCT/CN2024/125667, filed on Oct. 18, 2024.

(30) Foreign Application Priority Data
Oct. 31, 2023 (CN) 202311431364.0

(51) Int. Cl. G06V 10/77; G06Q 20/40; G06V 10/74; G06V 10/764; G06V 40/12

(52) U.S. Cl. CPC G06V 10/7715; G06Q 20/40145; G06V 10/761; G06V 10/764; G06V 40/1347

(57) ABSTRACT

Embodiments of this application provide a feature extraction network training method, a classification method, an apparatus, and an electronic device. The method includes: adjusting initial class center matrices respectively corresponding to a plurality of class centers of each of a plurality of classes, and an image feature of the first sample image extracted from a to-be-trained feature extraction network, a parameter of the to-be-trained feature extraction network and the initial class center matrices, to obtain a preliminarily trained feature extraction network and first class center matrices respectively corresponding to the class centers; and adjusting the first class center matrices, and an image feature of the second sample image extracted from the preliminarily trained feature extraction network, a parameter of the preliminarily trained feature extraction network, to obtain a trained feature extraction network.

### RELATED APPLICATION

This application is a continuation of PCT/CN2024/125667, filed on Oct. 18, 2024, which claims priority to Chinese Patent Application No. 202311431364.0, filed with the China National Intellectual Property Administration on Oct. 31, 2023, both entitled “FEATURE EXTRACTION NETWORK TRAINING METHOD, CLASSIFICATION METHOD, APPARATUS, AND ELECTRONIC DEVICE”, which are incorporated herein by reference in their entireties.

### FIELD OF THE TECHNOLOGY

This application relates to the field of artificial intelligence technologies, and more specifically, to a feature extraction network training method, a classification method, an apparatus, and an electronic device.

### BACKGROUND OF THE DISCLOSURE

A feature extraction network is a deep learning technology, and can extract useful features from input data, to perform effective classification and prediction.

When an image feature extraction network is trained with a sample set, the sample set generally includes a high-quality normal sample image and a low-quality difficult sample image (for example, a non-frontal sample image, a sample image with low definition, or a sample image with low pixels).

### SUMMARY

Embodiments of this application provide a feature extraction network training method, a classification method, an apparatus, and an electronic device, so that a feature of a difficult sample can approach a main class center of a corresponding class, to avoid a class center offset.

An embodiment of this application provides a feature extraction network training method. The method includes: performing the following operations in each iteration epoch of a first training stage: extracting an image feature of a first sample image by using a to-be-trained feature extraction network; determining a first loss based on the image feature of the first sample image, a class label of the first sample image, and initial class center matrices respectively corresponding to a plurality of class centers of each of a plurality of classes; and adjusting, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class; and performing the following operations in each iteration epoch of a second training stage: extracting an image feature of a second sample image by using the preliminarily trained feature extraction network; determining a second loss based on the image feature of the second sample image, a class label of the second sample image, and a first class center matrix corresponding to a main class center of each class, a main class center of one class being one of a plurality of class centers of the class; and adjusting, based on the second loss, a parameter of the preliminarily trained feature extraction network and the first class center matrix corresponding to the main class center of each class, until a second training stage ending condition is met, to obtain a trained feature extraction network, the trained feature extraction network being configured for image classification.

An embodiment of this application further provides an image classification method. The method includes: obtaining a to-be-classified image; performing feature extraction on the to-be-classified image by using the trained image feature extraction network obtained by using the foregoing feature extraction network training method, to obtain a target image feature; and determining a classification result of the to-be-classified image based on the target image feature.

An embodiment of this application further provides a feature extraction network training apparatus. The apparatus includes a first feature extraction module, a first loss determining module, a first adjustment module, a second feature extraction module, a second loss determining module, and a second adjustment module. The first feature extraction module is configured to extract an image feature of a first sample image by using a to-be-trained feature extraction network. The first loss determining module is configured to determine a first loss based on the image feature of the first sample image, a class label of the first sample image, and initial class center matrices respectively corresponding to a plurality of class centers of each of a plurality of classes. The first adjustment module is configured to adjust, based on the first loss, a parameter of the to-be-trained feature extraction network and the initial class center matrices respectively corresponding to the plurality of class centers of each class, to obtain a preliminarily trained feature extraction network and first class center matrices respectively corresponding to the plurality of class centers of each class. The second feature extraction module is configured to extract an image feature of a second sample image by using the preliminarily trained feature extraction network. The second loss determining module is configured to determine a second loss based on the image feature of the second sample image, a class label of the second sample image, and a first class center matrix corresponding to a main class center of each class, a main class center of one class being one of a plurality of class centers of the class. The second adjustment module is configured to adjust, based on the second loss, a parameter of the preliminarily trained feature extraction network and the first class center matrix corresponding to the main class center of each class, to obtain a trained feature extraction network, the trained feature extraction network being configured for image classification.

An embodiment of this application further provides an image classification apparatus. The apparatus includes an image obtaining module, a third feature extraction module, and a classification result determining module. The image obtaining module is configured to obtain a to-be-classified image. The third feature extraction module is configured to perform feature extraction on the to-be-classified image by using the trained image feature extraction network obtained by using the foregoing feature extraction network training apparatus, to obtain a target image feature. The classification result determining module is configured to determine a classification result of the to-be-classified image based on the target image feature.

An embodiment of this application further provides an electronic device, including a processor and a memory. One or more programs are stored in the memory and configured to be executed by the processor to implement the foregoing method.

An embodiment of this application further provides a computer-readable storage medium, the computer-readable storage medium having program code stored therein. When the program code is run by a processor, the foregoing method is performed.

An embodiment of this application further provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, to enable the computer device to perform the foregoing method.

### BRIEF DESCRIPTION OF THE DRAWINGS

FIG. 1 is a diagram of an application scenario of a feature extraction network training method according to an embodiment of this application.

FIG. 2 is a schematic flowchart of a feature extraction network training method according to an embodiment of this application.

FIG. 3 is a schematic diagram of a clipped palm print pixel area according to an embodiment of this application.

FIG. 4 is a schematic diagram of a network structure of a feature extraction network according to an embodiment of this application.

FIG. 5 is another schematic flowchart of a feature extraction network training method according to an embodiment of this application.

FIG. 6 is a schematic flowchart of an image classification method according to an embodiment of this application.

FIG. 7 is a flowchart of an application of a feature extraction network according to an embodiment of this application.

FIG. 8 is a connection block diagram of a feature extraction network training apparatus according to an embodiment of this application.

FIG. 9 is a connection block diagram of an image classification apparatus according to an embodiment of this application.

FIG. 10 is a block diagram of a structure of an electronic device configured to perform a method according to an embodiment of this application.

### DESCRIPTION OF EMBODIMENTS

Exemplary implementations are now to be described more thoroughly with reference to the accompanying drawings. However, the exemplary implementations may be implemented in various forms, and are not to be understood as being limited to the examples described herein. Instead, the implementations are provided to make this application more thorough and complete and fully convey the idea of the exemplary implementations to a person skilled in the art.

In addition, the described features, structures or characteristics may be combined in one or more embodiments in any appropriate manner. In the following descriptions, a lot of specific details are provided to give a comprehensive understanding of embodiments of this application. However, a person of ordinary skill in the art is to be aware that, the technical solutions in this application may be implemented without one or more of the particular details, or another method, unit, apparatus, or operation may be used. In other cases, well-known methods, apparatuses, implementations, or operations are not shown or described in detail, in order not to obscure the aspects of this application.

The block diagrams shown in the accompanying drawings are merely function entities and do not necessarily correspond to physically independent entities. That is, the function entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change based on an actual case.

“Plurality of” mentioned in the specification means two or more. “And/or” describes an association relationship of associated objects and represents that three relationships may exist. For example, A and/or B may represent the following three cases: Only A exists, both A and B exist, and only B exists. The character “/” in this specification usually represents an “or” relationship between the associated objects.

In some methods, when an image feature extraction network is trained by using a sample set, the sample set generally includes a high-quality normal sample image, and also includes a low-quality difficult sample image. When the image feature extraction network is trained by using the sample set, the difficult sample image easily causes a class center distribution offset in a training process, affecting a training effect. To resolve the foregoing problem, this application provides training of the feature extraction network in two stages, which is described in detail below.

The solutions of this application mainly use machine learning to perform image classification.

In this application, a plurality of class centers are set for each of a plurality of classes. For each class, one class center of the class is equivalent to one sub-class of the class. That is, in this application, a plurality of sub-classes are set for each class. One class center corresponds to one initial class center matrix, and the initial class center matrix is feature space of the class center. A plurality of class centers of each class are pre-constructed, an initial class center matrix corresponding to each class center is a fully connected matrix, and quantities of class centers of different classes may be the same or may be different. Before the feature extraction network is trained, initial values may be set for initial class center matrices respectively corresponding to the plurality of class centers of each class. Initial values of initial class center matrices corresponding to different class centers may be the same or may be different.

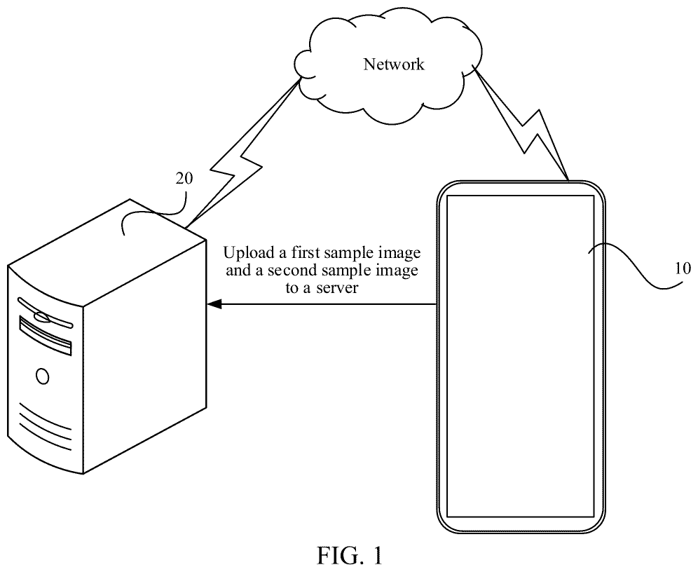

FIG. 1 is a schematic diagram of an application scenario according to an embodiment of this application. As shown in FIG. 1, the application scenario includes a terminal device 10 and a server 20 that is in communication connection with the terminal device 10 via a network.

Terminal device 10: The terminal device 10 may be specifically a mobile phone, a computer, an intelligent voice interaction device, a smart home appliance, an in-vehicle terminal, or the like. The terminal device 10 may be provided with a client for displaying data. The network may be a wide area network or a local area network, or a combination of both.

The server 20 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

If a feature extraction network is trained by using the terminal device 10 and the server 20 shown in FIG. 1, the terminal device 10 may upload a first sample image and a second sample image to the server 20. After obtaining the first sample image and the second sample image, the server 20 performs the following operations in each iteration epoch of a first training stage: extracting an image feature of the first sample image by using a to-be-trained feature extraction network; determining a first loss based on the image feature of the first sample image, a class label of the first sample image, and initial class center matrices respectively corresponding to a plurality of class centers of each class; and adjusting, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class; and performing the following operations in each iteration epoch of a second training stage: extracting an image feature of the second sample image by using the preliminarily trained feature extraction network; determining a second loss based on the image feature of the second sample image, a class label of the second sample image, and a first class center matrix corresponding to a main class center of each class, a main class center of one class being one of a plurality of class centers of the class; and adjusting, based on the second loss, a parameter of the preliminarily trained feature extraction network and the first class center matrix corresponding to the main class center of each class, until a second training stage ending condition is met, to obtain a trained feature extraction network, the trained feature extraction network being configured for image classification.

In this application, by using the foregoing method, it may be implemented that, in a model training process of a large quantity of training samples including many low-quality difficult samples, by setting a plurality of class centers for each class in a plurality of classes corresponding to a classification task, in the first training stage of the feature extraction network, the parameter of the to-be-trained feature extraction network and the initial class center matrices respectively corresponding to the plurality of class centers of each class are adjusted based on the first loss determined based on the image feature of the first sample image, the class label of the first sample image, and the initial class center matrices respectively corresponding to the plurality of class centers of each class, so that for each class, all image features of sample images (such as a normal sample image and a difficult sample image) belonging to the class can be mapped to one of a plurality of class centers corresponding to the class. In the second training stage of the feature extraction network, after the main class center is determined, the parameter of the preliminarily trained feature extraction network and the first class center matrix corresponding to the main class center of each class are adjusted based on the second loss determined based on the image feature of the second sample image, the class label of the second sample image, and the first class center matrix corresponding to the main class center of each class. In this way, image features extracted by using the preliminarily trained feature extraction network from difficult samples in the second sample image gradually approach the main class center, so as to improve feature extraction performance of low-quality difficult sample images in the second sample image while ensuring feature extraction performance of the preliminarily trained feature extraction network for normal samples in the second sample image, thereby improving accuracy of feature extraction of the trained feature extraction network.

After training of the feature extraction network is completed, the trained feature extraction network may be deployed on the server 20, so that after a to-be-classified image is obtained, the trained image feature extraction network is used to perform feature extraction on the to-be-classified image, to obtain a target image feature. Based on the target image feature, subsequent image processing operations, such as an image classification operation, are performed.

The following describes embodiments of this application in detail with reference to the accompanying drawings.

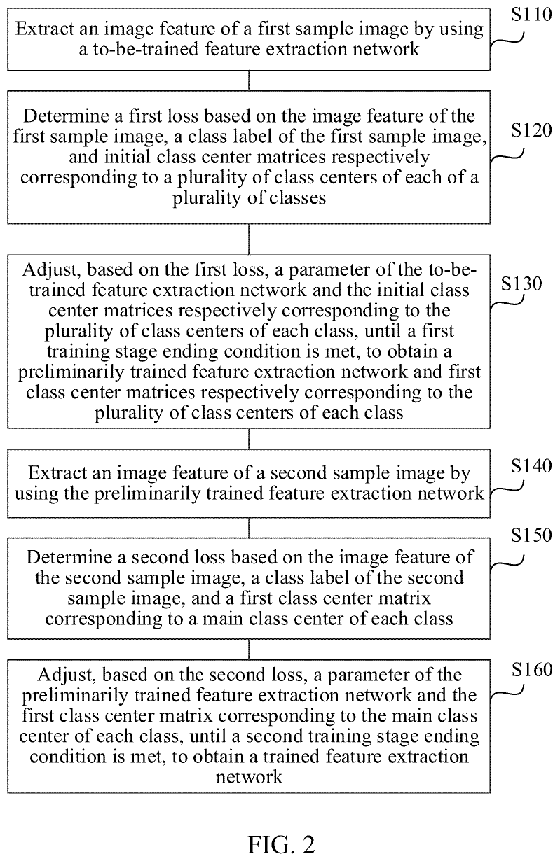

Refer to FIG. 2. FIG. 2 shows a feature extraction network training method further provided according to this application. The method may be applied to an electronic device. The electronic device may be the foregoing terminal device 10 or server 20. The method includes a first training stage and a second training stage.

The following operation S110 to operation S130 are performed in each iteration epoch of the first training stage.

Operation S110: Extract an image feature of a first sample image by using a to-be-trained feature extraction network.

A manner of obtaining the first sample image may be obtaining the first sample image after marking images in an image set, or may be obtaining, from the electronic device or another device associated with the electronic device, a plurality of prestored images having sample class labels as the first sample images. This may be set based on an actual requirement.

There are a plurality of first sample images, and each first sample image is labeled with a class label. The class label may be set based on a classification task, and a class corresponding to the class label of the first sample image belongs to one of a plurality of classes in the classification task. If the classification task is identifying whether an image is qualified, the class label of the sample image is qualified or unqualified. If the classification task is configured for classifying an object (for example, an animal or a plant) in an image, for example, configured for classifying animals such as a cat, a dog, or a pig, the class label of the sample image may be a specific class to which the object in the image belongs. If the classification task is configured for identifying whether an image is an abnormal image, the class label of the sample image is normal or abnormal. If the classification task is identifying identification information specifically corresponding to an image, the class label of the sample image is identification information of an object.

An example in which the classification task is performing identification classification based on biological feature information (for example, a facial image, a fingerprint image, a palm print image, or an iris image) of an object is used, the class label is identification information of an object, and the identification information may be information, for example, an object name or an object identity (ID), configured for identifying uniqueness of the object. In this manner, the first sample image may be obtained by extracting a specified area in an initial image. Specifically, key point detection may be performed on the initial image, and a specified area (for example, a facial pixel area, a fingerprint pixel area, a palm print pixel area, or an iris pixel area) is clipped from the initial image based on a key point detection result, to serve as the first sample image.

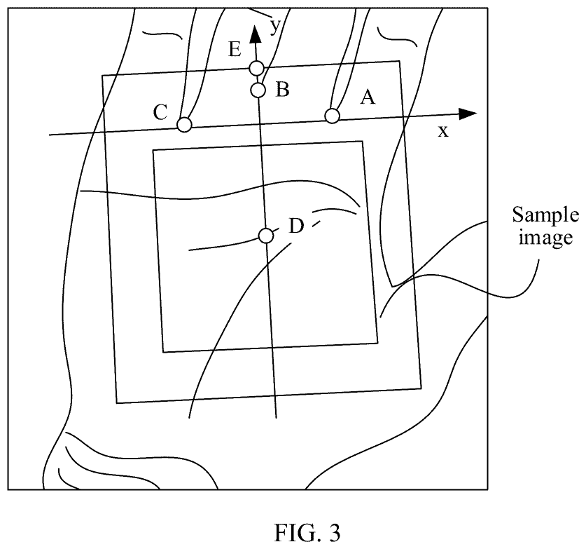

As shown in FIG. 3, for example, when the biological feature information is palm print information, the manner of obtaining the first sample image may be performing key point detection on the initial image, to obtain key points in the initial image. The key points in the initial image include a first finger gap key point A between the index finger and the middle finger, a second finger gap key point B between the middle finger and the ring finger, and a third finger gap key point C between the ring finger and the little finger. An image coordinate system is established based on the first finger gap key point A, the second finger gap key point B, and the third finger gap key point C in the initial image, a connection line between the first finger gap key point A and the third finger gap key point C being a horizontal axis (x axis) of the image coordinate system, a line that is perpendicular to the horizontal axis and passes through the second finger gap key point B being a vertical axis (y axis) of the image coordinate system, and an intersection point between the horizontal axis and the vertical axis being an origin of the image coordinate system. In the initial image, a point on the vertical axis of the image coordinate system and at a specified distance away from the origin of the image coordinate system is used as a palm print center point D in the initial image, the specified distance may be determined based on a distance between the first finger gap key point A and the third finger gap key point C, and the palm print center point D and the second finger gap key point B are respectively located at two sides of the horizontal axis. Sample images are clipped from the initial image based on the palm print center point D and the distance between the first finger gap key point A and the third finger gap key point C.

Specifically, after the image coordinate system shown in FIG. 3 is determined based on the first finger gap key point A, the second finger gap key point B, and the third finger gap key point C, the palm print center point D is found along a negative direction of the y axis at a distance of an AC length from the coordinate origin, and a DE distance is equal to six-fifths times the AC distance. The distance between the point A and the point C multiplied by 3/2 is used as a side length d of a palm print pixel area, and the palm print pixel area is extracted as the sample image (that is, the first sample image) with the point D as a center and d as the side length of the square.

When biological features of the objects are different, corresponding manners of clipping the image of the specified area from the initial image are different. Details are not described herein.

The feature extraction network may be constructed by using one or more neural networks. Specifically, the foregoing neural network may be any neural network that can perform image feature extraction, for example, a ResNet residual network, a DenseNet classic network, a VGG convolutional neural network, an AlexNet deep convolutional neural network, a Swin-Transformer network, a MaxViT network, or a LeNet convolutional neural network. This is not specifically limited in this embodiment.

Operation S120: Determine a first loss based on the image feature of the first sample image, the class label of the first sample image, and initial class center matrices respectively corresponding to a plurality of class centers of each of a plurality of classes.

Operation S120 may be determining a class prediction result of the first sample image based on similarities between the image feature of the first sample image and the initial class center matrices respectively corresponding to the plurality of class centers of each class, and performing loss calculation based on the class prediction result of the first sample image and the class label of the first sample image, to obtain the first loss.

In this manner, a manner of determining a class prediction result of the first sample image based on similarities between the image feature of the first sample image and the initial class center matrices respectively corresponding to the plurality of class centers of each class may be specifically: for each class, determining an average value or a largest value of the similarities between the image feature of the first sample image and the initial class center matrices respectively corresponding to the plurality of class centers of the class as a reference similarity between the image feature of the first sample image and the class, and determining a possibility that the first sample image belongs to each class based on the reference similarity between the image feature of the first sample image and the class. The reference similarity between the image feature of the first sample image and the class reflects a difference between the image feature corresponding to the first sample image and feature space corresponding to the class. A smaller difference indicates a larger possibility that the first sample image is predicted to be of the class. The possibility that the first sample image is predicted to be of each class is the class prediction result of the first sample image.

Operation S120 may alternatively be determining at least one reference class center in the plurality of class centers corresponding to each class based on the similarities between the image feature of the first sample image and the initial class center matrices respectively corresponding to the plurality of class centers of each class, determining the class prediction result of the first sample image based on a similarity between each reference class center of each class and the image feature of the first sample image, and performing loss calculation based on the class prediction result of the first sample image and the class label of the first sample image, to obtain the first loss.

The similarities between the image feature of the first sample image and the initial class center matrices respectively corresponding to the plurality of class centers of each class reflect differences between the image feature corresponding to the first sample image and feature space corresponding to the initial class center matrices of the plurality of class centers of each class. A similarity between a reference class center and the image feature of the first sample image also reflects a difference between feature space corresponding to the reference class center and the image feature. A smaller difference indicates a greater possibility that a predicted class of the first sample image is a class corresponding to the reference class center.

A manner of calculating a similarity between an initial class center matrix corresponding to one class center and the image feature of the first sample image may be calculating a cosine similarity, a Euclidean distance, or the like between the initial class center matrix corresponding to the class center and the image feature of the first sample image.

When loss calculation is performed on the class prediction result of the first sample image and the class label of the first sample image, the loss calculation may be performed on the class prediction result of the first sample image and the class label of the first sample image by using a preset loss function. The preset loss function may be a cross-entropy loss function, a mean-square error loss function, a multi-class cross-entropy loss function, or the like. This may be set based on an actual requirement.

Operation S130: Adjust, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class.

In this embodiment, when a quantity of iterations in the first training stage reaches a first preset quantity of times, a quantity of epochs corresponding to the iteration epoch reaches a first preset quantity of epochs, or the first loss is less than a first preset loss threshold, it may be considered that training of the to-be-trained feature extraction network reaches the first training stage ending condition. In addition, when the training of the to-be-trained feature extraction network reaches the first training stage ending condition, the to-be-trained feature extraction network after a last time of iterative adjustment is used as the preliminarily trained feature extraction network, and the initial class center matrices that are obtained after the last time of iterative adjustment and that respectively correspond to the plurality of class centers of each class are used as the first class center matrices respectively corresponding to the plurality of class centers of each class. The first preset quantity of times, the first preset quantity of epochs, and the first preset loss threshold may be set based on a task requirement, and are not specifically limited herein.

A plurality of first training sets may be set to participate in the training process of operation S110 to operation S130. Each first training set includes a plurality of first sample images. If all first sample images in one first training set participate in training of the to-be-trained feature extraction network once, it is considered that one iteration epoch is completed. In some embodiments, the first sample images in each first training set may be input into the to-be-trained feature extraction network in batches, to perform iterative training. A batch quantity corresponding to each batch may be set based on an actual requirement.

Iterative adjustment is performed on the parameter of the to-be-trained feature extraction network and the initial class center matrices respectively corresponding to the plurality of class centers of each class, so that feature space respectively corresponding to the plurality of class centers of each class can be constrained while accuracy of feature extraction of the to-be-trained feature extraction network is improved.

The following operation S140 to operation S160 are performed in each iteration epoch of the second training stage.

Operation S140: Extract an image feature of a second sample image by using the preliminarily trained feature extraction network.

A manner of obtaining the second sample image is to be the same as or similar to the manner of obtaining the first sample image, and a class corresponding to the second sample image is also one of a plurality of classes corresponding to a classification task when the preliminarily trained feature extraction network is used as the classification task. Therefore, for processes such as obtaining and processing the second sample image, refer to the foregoing related descriptions of the first sample image. This is not specifically limited herein again.

There are a plurality of second sample images. The second sample image may be different from the first sample image. Alternatively, the first sample image may participate, as the second sample image, in training of the preliminarily trained feature extraction network.

For specific descriptions of extracting the second sample image by using the preliminarily trained feature extraction network, refer to the foregoing specific descriptions of operation S110. Details are not described herein.

Operation S150: Determine a second loss based on the image feature of the second sample image, a class label of the second sample image, and a first class center matrix corresponding to a main class center of each class.

A main class center of one class is one of a plurality of class centers of the class.

A main class center of one class refers to a class center corresponding to feature space (a class center matrix) in which features of images of the class are mainly distributed.

In some implementations, a main class center of one class may be determined based on quantities of sample images (for example, first sample images) attached to a plurality of class centers of the class. For example, a class center having a largest quantity of attached first sample images in the plurality of class centers of the class is determined as the main class center of the class.

In some other implementations, because there are a plurality of first sample images, when the main class center of the class is determined, a reference image set corresponding to each class may be determined, a reference image set corresponding to one class including a plurality of first sample images having a class label the same as that of the class. For each class center of each class, a reference similarity corresponding to the class center is determined based on a similarity between an initial class center matrix of the class center and an image feature of each first sample image in the reference image set corresponding to the class. For each class, a class center having a largest reference similarity of the class is determined as a main class center of the class.

In this implementation, for each class center of each class, one of an average value, a largest value, a median, or the like of similarities between the initial class center matrix of the class center and image features of first sample images in the reference image set corresponding to the class may be determined as the reference similarity corresponding to the class center.

In some implementations, there are a plurality of second sample images. Operation S150 may alternatively be performing similarity calculation on the image feature of each second sample image and the first class center matrix corresponding to the main class center of each class, to obtain a second similarity between the image feature of each second sample image and the main class center of each class; using a class to which a main class center having a largest second similarity with the image feature of the second sample image belongs in the plurality of classes as a predicted class of the second sample image; and determining the second loss based on the class label of the second sample image and the predicted class of the second sample image.

A manner of calculating the second similarity between the image feature of each second sample image and the main class center of each class may be similar to the foregoing calculation process of calculating the similarity between the image feature of the first sample image and the initial class center matrix corresponding to each class center, and a process of determining the second loss may also be similar to the foregoing process of determining the first loss. Details are not described herein.

The foregoing manners of obtaining the second loss are merely exemplary, and there may be more obtaining manners. Details are not described one by one in this embodiment.

Operation S160: Adjust, based on the second loss, a parameter of the preliminarily trained feature extraction network and the first class center matrix corresponding to the main class center of each class, until a second training stage ending condition is met, to obtain a trained feature extraction network.

In this embodiment, the trained feature extraction network may be configured for image classification.

In this embodiment, when a quantity of iterations of the preliminarily trained feature extraction network reaches a second preset quantity of times, a quantity of epochs corresponding to the iteration epoch reaches a second preset quantity of epochs, or the second loss is less than a second preset loss threshold, it may be considered that training of the preliminarily trained feature extraction network reaches the second training stage ending condition. In addition, when the training of the preliminarily trained feature extraction network reaches the second training stage ending condition, the preliminarily trained feature extraction network after a last time of iterative adjustment is used as the trained feature extraction network. The second preset quantity of times, the second preset quantity of epochs, and the second preset loss threshold may be set based on a task requirement, and are not specifically limited herein.

In a training process of the preliminarily trained feature extraction network, the parameter of the preliminarily trained feature extraction network and the first class center matrix corresponding to the main class center of each class are adjusted based on the second loss, to constrain, in the training process, image features extracted by using the preliminarily trained feature extraction network from the second sample images to gradually approach a main class center of a corresponding class. In other words, even if the second sample image is a difficult sample, for example, a non-frontal sample image, a sample image with low definition, or a sample image with low pixels, the image feature extracted by using the preliminarily trained feature extraction network from the second sample image as the difficult sample may also be constrained to approach the main class center of the corresponding class, so that the trained feature extraction network not only can ensure accuracy of accurately performing feature extraction on a normal image, but also can improve accuracy of accurately performing feature extraction on a low-quality image, thereby ensuring accurate classification of a low-quality or difficult image.

In the feature extraction network training method provided in this embodiment of this application, a plurality of class centers are set for each class, and the parameter of the to-be-trained feature extraction network and the initial class center matrices respectively corresponding to the plurality of class centers of each class are adjusted based on the first loss determined based on the image feature of the first sample image, the class label of the first sample image, and the initial class center matrices respectively corresponding to the plurality of class centers of each class, so that feature space respectively corresponding to the plurality of class centers of each class can be constrained while accuracy of feature extraction of the to-be-trained feature extraction network is improved. Subsequently, the parameter of the preliminarily trained feature extraction network and the first class center matrix corresponding to the main class center of each class are adjusted based on the second loss determined based on the image feature of the second sample image, the class label of the second sample image, and the first class center matrix corresponding to the main class center of each class. In this way, in a training process, the image features extracted by using the preliminarily trained extraction network gradually approach the main class center of each class. That is, even if the second sample image is a difficult sample, a feature of the difficult sample may also approach the main class center of the corresponding class. This resolves a problem of a class center offset caused by the difficult sample, and may improve feature extraction performance of low-quality difficult samples in the sample image while ensuring feature extraction performance of the trained feature extraction network for normal samples in the sample image, thereby improving accuracy of feature extraction of the trained feature extraction network.

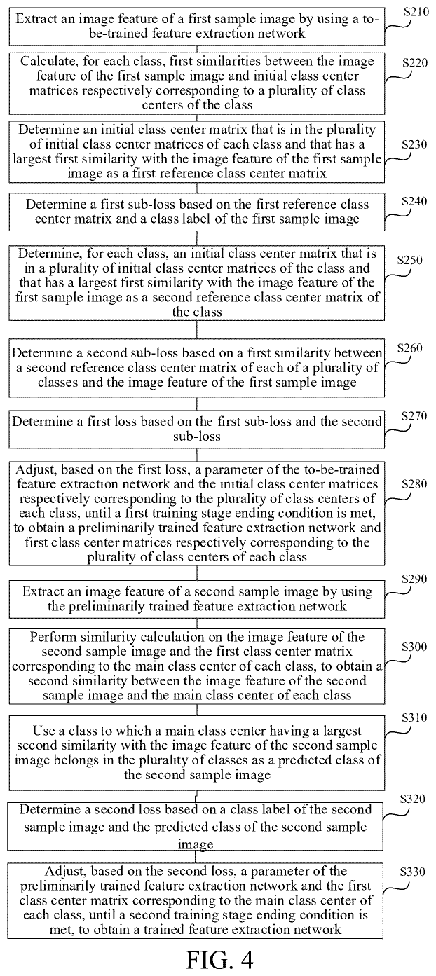

Refer to FIG. 4. An embodiment of this application provides a feature extraction network training method. The method includes:

Operation S210: Extract an image feature of a first sample image by using a to-be-trained feature extraction network.

For specific descriptions of operation S210, refer to the foregoing specific descriptions of operation S110. Details are not described herein again.

Operation S220: Calculate, for each class, first similarities between the image feature of the first sample image and initial class center matrices respectively corresponding to a plurality of class centers of the class.

For a process of calculating the similarity between the image feature and the class center matrix, refer to the foregoing specific descriptions. Details are not described herein again.

Operation S230: Determine an initial class center matrix that is in the plurality of initial class center matrices of each class and that has a largest first similarity with the image feature of the first sample image as a first reference class center matrix.

That is, the first reference class center matrix is the initial class center matrix that is in a plurality of class center matrices of a plurality of classes and that has the largest first similarity with the image feature of the first sample image.

Operation S240: Determine a first sub-loss based on the first reference class center matrix and a class label of the first sample image.

A class to which a class center corresponding to the first reference class center matrix belongs may be used as a predicted class corresponding to the first sample image. The first sub-loss is configured for reflecting a difference between the predicted class corresponding to the first sample image and a class indicated by the class label of the first sample image. A smaller difference between the predicted class corresponding to the first sample image and the class indicated by the class label of the first sample image indicates higher accuracy of the image feature extracted by the to-be-trained feature extraction network.

Operation S250: Determine, for each class, an initial class center matrix that is in a plurality of initial class center matrices of the class and that has a largest first similarity with the image feature of the first sample image as a second reference class center matrix of the class.

For one class, a second reference class center matrix of the class is an initial class center matrix that is of the class and that has a largest first similarity with the image feature of the first sample image.

Operation S260: Determine a second sub-loss based on a first similarity between a second reference class center matrix of each of the plurality of classes and the image feature of the first sample image.

Specifically, the second sub-loss may be determined based on a sum or an average value of first similarities between second reference class center matrices of the plurality of classes and the image feature of the first sample image.

Operation S270: Determine a first loss based on the first sub-loss and the second sub-loss.

A manner of determining the first loss based on the first sub-loss and the second sub-loss may be performing weighted summation on the first sub-loss and the second sub-loss to obtain the first loss, or may be determining the sub-loss having a larger loss value between the first sub-loss and the second sub-loss as the first loss. This may be set based on an actual requirement.

In some implementations, operation S270 includes:

Operation S270a: Determine a first interval parameter and a first scaling coefficient based on a first quantity of epochs corresponding to an iteration epoch that the first sample image participates in, the first interval parameter and the first scaling coefficient being negatively correlated to the first quantity of epochs.

The first quantity of epochs refers to the quantity of epochs corresponding to the iteration epoch that the first sample image participates in. That is, if the first sample image participates in a kl iteration epoch, the first quantity of epochs corresponding to the iteration epoch that the first sample image participates in is k. Different first sample images may participate in different iteration epochs, and corresponding first quantities of epochs may also be different.

The first interval parameter and the first scaling coefficient are determined based on the first quantity of epochs corresponding to the iteration epoch that the first sample image participates in, so that a parameter can be set adaptively, and a surveillance loss is loose, ensuring that feature distribution of a normal sample is not affected. At the same time, this avoids a case in which the feature extraction network is easily affected by a difficult sample due to an unstable gradient at an early training stage. In addition, the first interval parameter and the first scaling coefficient are negatively correlated to the first quantity of epochs. In this way, a larger first quantity of epochs indicates a smaller first interval parameter and a smaller first scaling coefficient. As a quantity of iteration epochs increases, the first interval parameter and the first scaling coefficient are gradually reduced, so that a loss requirement can be gradually improved.

Operation S270b: Calculate an additive angular interval loss based on the first interval parameter, the first scaling coefficient, the first sub-loss, and the second sub-loss, to obtain the first loss.

Specifically, the first loss may be obtained through calculation by using a first additive angular interval loss calculation formula based on the first interval parameter, the first scaling coefficient, the first sub-loss, and the second sub-loss. The first additive angular interval loss calculation formula is as follows:

$${loss}_{earlystage} = {\sum }_{i = 1}^{G} - log \frac{{e}^{{S}_{1} \cdot cos ( {θ}_{i , yi} ) + {m}_{1}}}{{e}^{{S}_{1} \cdot cos ( {θ}_{i , yi} ) + {m}_{1}} + {\sum }_{j = 1}^{C} {e}^{{S}_{1} \cdot cos ( {θ}_{i , j} )}} .$$

loss_{earlystage} is the first loss. _{cos} (θ_{i,yi}) is the first sub-loss, and is determined based on the class label yi of the first sample image and the first reference class center matrix that is in the plurality of class center matrices of the plurality of classes and that has the largest first similarity with the image feature of the first sample image. _{cos} (θ_{i,j}) is the second sub-loss, and is determined based on the first similarity between the second reference class center matrix of each of the plurality of classes and the image feature of the first sample image. s₁ is the first interval parameter. m₁ is the first scaling coefficient. G represents a quantity of first sample images input in one iterative training process. θ_{i,yi} represents an included angle between a class corresponding to a classification label of the input first sample image and a class corresponding to the reference class center matrix. θ_{i,j} represents an included angle between the class corresponding to the classification label of the input first sample image and a class corresponding to a ji class center. Specifically, θ_{i,j}=arccos(max_{f}(W_{jf}x)), f=1, 2 . . . , F. x represents the image feature. W_{jf} represents an initial class center matrix of an f^{th} class center of a j^{th} class. max_{f}(W_{jf}x) is taking a maximum value of the similarity between the image feature and the initial class center matrix. arccos( ) is an inverse cosine function.

In some implementations, a process of determining the first interval parameter and the first scaling coefficient may be specifically: determining a first coefficient based on the first quantity of epochs corresponding to the iteration epoch that the first sample image participates in, the first coefficient being negatively correlated to the first quantity of epochs; determining a first interval adjustment value based on the first coefficient, and adding the first interval adjustment value and a first reference interval parameter, to obtain the first interval parameter; and determining a first scaling adjustment value based on the first coefficient, and adding the first scaling adjustment value and a first reference scaling coefficient, to obtain the first scaling coefficient.

For example, a first preset quantity of epochs may be subtracted from the first quantity of epochs corresponding to the iteration epoch that the first sample image participates in, to obtain a first difference value. A ratio of the first difference value to the first preset quantity of epochs is used as the first coefficient. The first coefficient is multiplied by the first reference interval parameter to obtain the first interval adjustment value, and the first interval adjustment value and the first reference interval parameter are added, to obtain the first interval parameter. The first coefficient is multiplied by a specified scaling coefficient, to obtain the first scaling adjustment value, and the first reference scaling coefficient and the first scaling adjustment value are added, to obtain the first scaling coefficient. The first preset quantity of epochs may be set as required, as long as it is ensured that a difference value between the first preset quantity of epochs and the first quantity of epochs is not less than zero. Specific values of the first reference interval parameter, the specified scaling coefficient, and the first reference scaling coefficient are not specifically limited herein. This may be set based on an actual requirement.

Operation S280: Adjust, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class.

Operation S290: Extract an image feature of a second sample image by using the preliminarily trained feature extraction network.

There are a plurality of second sample images.

Operation S300: Perform similarity calculation on the image feature of the second sample image and the first class center matrix corresponding to the main class center of each class, to obtain a second similarity between the image feature of the second sample image and the main class center of each class.

Operation S310: Use a class to which a main class center having a largest second similarity with the image feature of the second sample image belongs in the plurality of classes as a predicted class of the second sample image.

Operation S320: Determine a second loss based on a class label of the second sample image and the predicted class of the second sample image.

If the class label of the second sample image is consistent with the predicted class of the second sample image, the second loss is smaller. If the class label of the second sample image is inconsistent with the predicted class of the second sample image, the second loss is larger.

Considering that a parameter of the feature extraction network tends to be stable in a late training stage of the feature extraction network, and a main target of the training stage becomes to make a difficult sample far away from a class center corresponding to a normal sample approach the class center of the normal sample, a closer surveillance parameter needs to be used. In a parameter adjusting process, an adaptive parameter setting manner may be designed, so that a stricter surveillance policy is gradually used in the late training stage, to improve a compatibility capability of a model for the difficult sample while ensuring an identification effect of normal data. Specifically, in some implementations, operation S320 includes:

Operation S320a: Determine a second interval parameter and a second scaling coefficient based on a second quantity of epochs corresponding to an iteration epoch that the second sample image participates in, the second interval parameter and the second scaling coefficient being negatively correlated to the second quantity of epochs.

The second quantity of epochs refers to the quantity of epochs corresponding to the iteration epoch that the second sample image participates in. That is, if the second sample image participates in a z^{th} iteration epoch, the second quantity of epochs corresponding to the iteration epoch that the second sample image participates in is z. Different second sample images may participate in different iteration epochs, and corresponding second quantities of epochs may also be different.

The second interval parameter and the second scaling coefficient may be determined in the following manner: determining a second coefficient based on the second quantity of epochs corresponding to the iteration epoch that the second sample image participates in, the second coefficient being negatively correlated to the second quantity of epochs; determining a second interval adjustment value based on the second coefficient, and adding a second reference interval parameter and the second interval adjustment value, to obtain the second interval parameter; and determining a second scaling adjustment value based on the second coefficient, and adding a second reference scaling coefficient and the second scaling adjustment value, to obtain the second scaling coefficient.

For example, a second preset quantity of epochs is subtracted from the second quantity of epochs corresponding to the iteration epoch that the second sample image participates in, to obtain a second difference value through calculation, and the second difference value is compared with the second preset quantity of epochs to obtain the second coefficient. The second coefficient is multiplied by the second reference interval parameter to obtain the second interval adjustment value, and the second reference interval parameter and the second interval adjustment value are added, to obtain the second interval parameter. The second coefficient is multiplied by a set scaling coefficient, to obtain the second scaling adjustment value, and the second reference scaling coefficient and the second scaling adjustment value are added, to obtain the second scaling coefficient. The second preset quantity of epochs may be set as required, as long as it is ensured that a difference value between the second preset quantity of epochs and the second quantity of epochs is not less than zero. Specific values of the second reference interval parameter, the set scaling coefficient, and the second reference scaling coefficient are not specifically limited herein. This may be set based on an actual requirement.

In some embodiments, to ensure a training effect, the first interval parameter during training of the to-be-trained feature extraction network may be constrained to be less than or equal to the second interval parameter during training of the preliminarily trained feature extraction network, and the first scaling coefficient during training of the to-be-trained feature extraction network is constrained to be less than or equal to the second scaling coefficient during training of the preliminarily trained feature extraction network.

Operation S320b: Calculate an additive angular interval loss based on the second interval parameter, the second scaling coefficient, the class label of the second sample image, and the predicted class of the second sample image, to obtain the second loss.

Specifically, the additive angular interval loss may be calculated by using a second additive angular interval loss calculation formula based on the second interval parameter, the second scaling coefficient, the class label of the second sample image, and the predicted class of the second sample image, to obtain the second loss. The second additive angular interval loss calculation formula is as follows:

$${loss}_{latestage} = {\sum }_{i = 1}^{H} - log \frac{{e}^{{s}_{2} \cdot cos ( {θ}_{y i} ) + {m}_{2}}}{{e}^{{S}_{2} \cdot cos ( {θ}_{yi} ) + {m}_{2}} + {e}^{{S}_{2} \cdot cos ( {θ}_{y i} )}} .$$

los_{latestage} is the second loss. H is a batch quantity, that is, a quantity of second sample images input in one batch. _{cos} (θ_{y}_{ᵢ}) is a third sub-loss, and is determined based on the similarity between the image feature of the second sample image and the main class center of each class. s₂ is the second interval parameter. m₂ is the second scaling coefficient. θ_{yi} is an angle between the predicted class of the second sample image and a class corresponding to the class label of the second sample image.

Operation S330: Adjust, based on the second loss, a parameter of the preliminarily trained feature extraction network and the first class center matrix corresponding to the main class center of each class, until a second training stage ending condition is met, to obtain a trained feature extraction network.

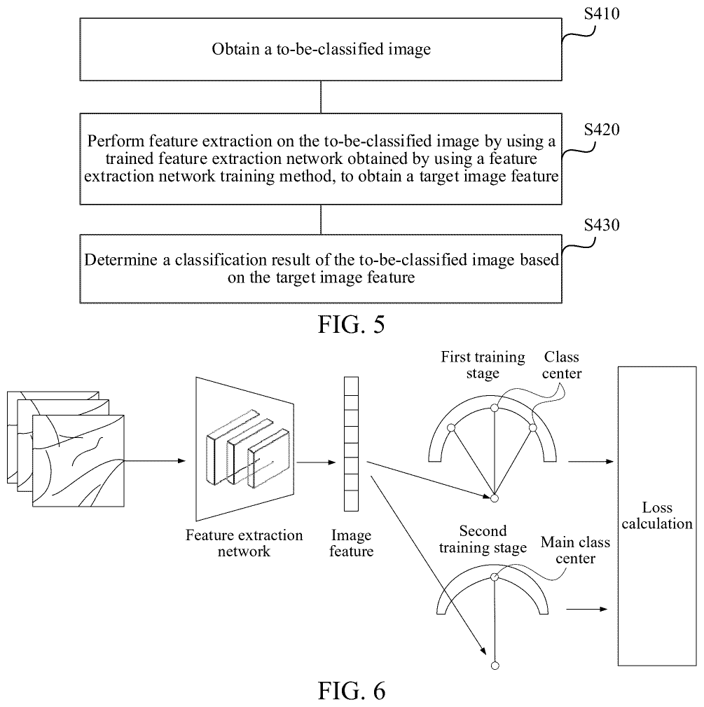

Refer to FIG. 5. An embodiment of this application further provides an image classification method. The method is applicable to the foregoing electronic device, and the method includes:

Operation S410: Obtain a to-be-classified image.

The to-be-classified image may be any image that needs to be classified, and an obtaining process thereof may be similar to that of obtaining the first sample image and the second sample image in the foregoing embodiments, and is not specifically limited herein.

To ensure accuracy of features obtained by subsequently performing feature extraction on the to-be-classified image, operation S410 may be obtaining an initial image, performing preprocessing on the initial image, for example, performing preprocessing such as denoising, enhancement, or filtering, and after a preprocessed initial image is obtained, for different classification tasks, performing different processing operations based on the classification tasks. For example, when the classification task is object identification, an area in which an object in the classification task is located may be clipped, or scaling processing may be performed on the object in the classification task.

In some implementable implementations, the to-be-classified image is a palm print image, and operation S410 includes:

Operation S412: Obtain a hand image.

Operation S414: Perform key point detection on the hand image, to obtain a finger gap key point in the hand image.

Operation S416: Clip a palm print pixel area from the hand image as the palm print image based on the finger gap key point in the hand image.

For a specific process of obtaining the palm print image, refer to the foregoing specific descriptions. Details are not described herein again.

Operation S420: Perform feature extraction on the to-be-classified image by using a trained feature extraction network obtained by using a feature extraction network training method, to obtain a target image feature.

Operation S430: Determine a classification result of the to-be-classified image based on the target image feature.

When application scenarios corresponding to the trained feature extraction network are different, manners of determining the classification result of the to-be-classified image are different. If the application scenario corresponding to the trained feature extraction network is an identification and authentication scenario, the classification result of the to-be-classified image is that authentication succeeds or authentication fails. If the application scenario corresponding to the trained feature extraction network is a multi-classification scenario, the classification result of the to-be-classified image is a class to which the to-be-classified image specifically belongs. If the trained feature extraction network is applied to an image anomaly identification scenario, the classification result of the to-be-classified image is that the to-be-classified image is normal or abnormal. The foregoing application scenarios of the trained feature extraction network are merely exemplary, and classification manners determined in different application scenarios and classification results obtained are different.

If the trained feature extraction network application is in the identification and authentication scenario, operation S430 may be that the classification result of the to-be-classified image includes an authentication result. Operation S430 may be specifically matching the target image feature with a preset reference image feature, and if there is the preset reference image feature matching the target image feature, generating authentication information including that authentication succeeds, or using authentication information associated with the preset reference image feature as authentication information of the to-be-classified image.

In this implementation, operation S430 may specifically include:

Operation S432: Perform similarity calculation on the target image feature and a plurality of reference image features in a preset database, to obtain similarities between the target image feature and the reference image features.

Operation S434: Determine, based on the similarities between the target image feature and the reference image features, a target reference image feature having a largest similarity with the target image feature.

Operation S436: Use authentication information associated with the target reference image feature as the authentication result of the to-be-classified image.

In this manner, if authentication succeeds, subsequent operations may be performed, such as unlocking data of some applications, payment, unlocking a device, passing-through a gate, and opening a smart lock.

In some implementations, after the using authentication information associated with the target reference image feature as the authentication result of the to-be-classified image, the method further includes: performing payment processing based on the authentication result of the to-be-classified image.

If the trained feature extraction network is applied to the multi-classification task scenario, different classes each have a main class center, and the main class center may be determined based on the foregoing feature extraction network training method. Operation S430 may be performing similarity calculation on an image feature of the to-be-classified image and a main class center corresponding to each class in a multi-classification task, to determine the classification result of the to-be-classified image based on a similarity between the image feature and the main class center of each class.

The foregoing manners of determining the classification result of the to-be-classified image are merely exemplary, and there may be more determining manners. Details are not described one by one in this embodiment.

As shown in FIG. 6, an embodiment of this application provides a feature extraction network training method. The feature extraction network obtained through training is configured for extracting palm print features of different users. Identification and authentication are performed on a to-be-identified palm print image by using the feature extraction network obtained through training, and payment is performed after the identification and authentication succeed. Specific training and application processes are as follows.

### Training Stage:

First, a plurality of initial images including a palm image are obtained. Each initial image corresponds to one piece of label information, and the label information is configured for representing an object to which the palm image belongs.

For each initial image, key points in the initial image are detected by using a target detection algorithm (for example, a yolov2 detection algorithm), to obtain a first finger gap key point A between the index finger and the middle finger, a second finger gap key point B between the middle finger and the ring finger, and a third finger gap key point C between the ring finger and the little finger. Then, an image coordinate system is established based on the first finger gap key point A, the second finger gap key point B, and the third finger gap key point C in the initial image, a connection line between the first finger gap key point A and the third finger gap key point C being a horizontal axis (x axis) of the image coordinate system, a line that is perpendicular to the horizontal axis and passes through the second finger gap key point B being a vertical axis (y axis) of the image coordinate system, and an intersection point between the horizontal axis and the vertical axis being an origin of the image coordinate system. In the initial image, a point on the vertical axis of the image coordinate system and at a specified distance away from the origin of the image coordinate system is used as a palm print center point D in the initial image, the specified distance is determined based on a distance between the first finger gap key point A and the third finger gap key point C, and the palm print center point D and the second finger gap key point B are respectively located at two sides of the horizontal axis. Sample images are clipped from the initial image based on the palm print center point D and the distance between the first finger gap key point A and the third finger gap key point C.

In this way, a first sample image and a second sample image may be obtained. There are a plurality of first sample images and a plurality of second sample images, and the first sample image and the second sample image may be the same or may be different.

After the first sample image and the second sample image are obtained, the first sample image and the second sample image may be scaled to a same size, to participate in subsequent training of the feature extraction network.

When the feature extraction network is trained, the feature extraction network is applied to a classification task, a quantity of classes in the classification task is set to E, initial values of initial class center matrices of a plurality of class centers of each class are respectively set to zero, the plurality of class centers corresponding to each class has a same quantity F, and an initial class center matrix corresponding to each class center is a fully connected linear matrix, and has a same length N. A class corresponding to a class label of the sample image is to belong to one of a plurality of classes in the classification task.

In a training process of a first stage, a quantity of first sample images input in each iteration is G, an image feature of the first sample image is extracted by using a to-be-trained feature extraction network. Then, for each class, first similarities between the image feature of the first sample image and initial class center matrices respectively corresponding to a plurality of class centers of the class are calculated. An initial class center matrix that is in a plurality of initial class center matrices of each class and that has a largest first similarity with the image feature of the first sample image is determined as a first reference class center matrix. A first sub-loss is determined based on the first reference class center matrix and a class label of the first sample image. An initial class center matrix that is in a plurality of initial class center matrices of each class and that has a largest first similarity with the image feature of the first sample image is determined as a second reference class center matrix of the class. A second sub-loss is determined based on a first similarity between a second reference class center matrix of each class and the image feature of the first sample image. Then, a first interval parameter and a first scaling coefficient are determined based on a first quantity of epochs corresponding to an iteration epoch that the first sample image participates in, the first interval parameter and the first scaling coefficient being negatively correlated to the first quantity of epochs. An additive angular interval loss is calculated based on the first interval parameter, the first scaling coefficient, the first sub-loss, and the second sub-loss, to obtain a first loss.

Specifically, the first loss may be obtained through calculation based on the following formula:

$${loss}_{earlystage} = {\sum }_{i = 1}^{G} - log \frac{{e}^{{S}_{1} \cdot cos ( {θ}_{i , yi} ) + {m}_{1}}}{{e}^{{S}_{1} \cdot cos ( {θ}_{i , yi} ) + {m}_{1}} + {\sum }_{j = 1}^{C} {e}^{{S}_{1} \cdot cos ( {θ}_{i , j} )}} .$$

loss_{earlystage} is the first loss. _{cos} (θ_{i,yi}) is the first sub-loss, and is determined based on the class label yi of the first sample image and the first reference class center matrix that is in the plurality of class center matrices of the plurality of classes and that has the largest first similarity with the image feature of the first sample image. _{cos} (θ_{i,j}) is the second sub-loss, and is determined based on the first similarity between the second reference class center matrix of each of the plurality of classes and the image feature of the first sample image. s₁ is the first interval parameter. m₁ is the first scaling coefficient. G represents a quantity of first sample images input in one iterative training process. θ_{i,yi} represents an included angle between a class corresponding to a classification label of the input first sample image and a class corresponding to the reference class center matrix. θ_{i,j} represents an included angle between the class corresponding to the classification label of the input first sample image and a class corresponding to a ji class center. Specifically, θ_{i,j}=arccos(max_{f}(W_{jf}x)), f=1, 2 . . . , F. x represents the image feature. W_{jf} represents an initial class center matrix of an f^{th} sub-class center of a j^{th} class.

In some embodiments, a first training stage is a stage in which the iteration epoch that the first sample image participates in is less than or equal to 10. Because a gradient of model learning is unstable and easily affected by a difficult sample, an adaptive parameter setting manner may be used, and a surveillance loss is loose, ensuring that feature distribution of a normal sample is not affected. A range of s₁ is limited to [24, 48], and a range of m₁ is limited to [0.3, 0.5]. Actual calculation formulas of the first interval parameter and the first scaling coefficient are as follows: s₁=24+(10−epoch1)/10*24; and m₁=0.3+(10−epoch1)/10*0.2. epoch1 refers to the quantity of epochs of the iteration epoch that the first sample image participates in.

After the first loss is obtained through calculation, a parameter of the to-be-trained feature extraction network and the initial class center matrices respectively corresponding to the plurality of class centers of each class are adjusted through gradient backpropagation, until a first training stage ending condition is met, to obtain a preliminarily trained feature extraction network and first class center matrices respectively corresponding to the plurality of class centers of each class, so that for each class, all image features of first sample images belonging to the class can be mapped to one of a plurality of class centers corresponding to the class.

In a training process of a second stage, there are a plurality of second sample images. An image feature of the second sample image is extracted by using the preliminarily trained feature extraction network. Similarity calculation is performed on the image feature of each second sample image and a first class center matrix corresponding to a main class center of each class, to obtain a second similarity between the image feature of each second sample image and the main class center of each class. A class to which a main class center having a largest second similarity with the image feature of the second sample image belongs in the plurality of classes is used as a predicted class of the second sample image. A second loss is determined based on a class label of the second sample image and the predicted class of the second sample image.

Specifically, the second loss may be obtained through calculation by using the following loss function:

$${loss}_{latestage} = {\sum }_{i = 1}^{H} - log \frac{{e}^{{S}_{2} \cdot cos ( {θ}_{y i} ) + {m}_{2}}}{{e}^{{S}_{2} \cdot cos ( {θ}_{yi} ) + {m}_{2}} + {e}^{{S}_{2} \cdot cos ( {θ}_{y i} )}} .$$

loss_{latestage} is the second loss. H is a batch quantity, that is, a quantity of second sample images input in one batch. _{cos} (θ_{y}_{ᵢ}) is a third sub-loss, and is determined based on the similarity between the image feature of the second sample image and the main class center of each class. s₂ is a second interval parameter. m₂ is a second scaling coefficient. θ_{yi} is an angle between the predicted class and a class corresponding to the class label.

In some embodiments, a second training stage is a stage in which an iteration epoch that the second sample image participates in is less than or equal to 10. In the second training stage, because a model parameter tends to be stable, and a main target becomes to make a difficult sample originally far away from a class center of a normal sample approach the class center of the normal sample, a closer surveillance parameter needs to be used. An adaptive parameter setting manner is also designed to limit a range of s₂ to [48, 64], and a range of m₂ to [0.5, 0.7]. Actual calculation formulas of the second interval parameter and the second scaling coefficient are as follows: s₂=48+(10−epoch2)/10*16; and m₂=0.5+(10−epoch2)/10*0.2. epoch2 refers to a quantity of epochs of the iteration epoch that the second sample image participates in.

The foregoing two stages of training may improve feature extraction performance of low-quality difficult sample images in the sample image while ensuring feature extraction performance of a trained feature extraction network for normal samples in the sample image, thereby improving accuracy of feature extraction of a trained target feature extraction network.

### Application Stage:

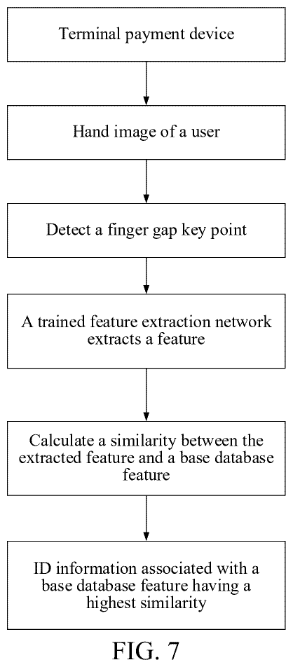

Refer to FIG. 7. When the foregoing trained feature extraction network is used for palm print identification payment, a hand image of a target object may be captured via a terminal payment device camera. A detection model detects finger gap key points of the target object. A palm area of interest is extracted based on the hand image and key point positions. A palm print image feature encoding vector corresponding to the palm area of interest is extracted by using the foregoing trained feature extraction network. A cosine similarity between the extracted palm print image feature encoding vector and a base database feature is calculated. A cosine similarity calculation formula is as follows:

$$sim ( {v}_{1} , {v}_{k} ) = \frac{\vec{{v}_{1}} \times \vec{{v}_{k}}}{\vert \vec{{v}_{1}} \vert \times \vert \vec{{v}_{k}} \vert} \cdot \vec{{v}_{1}}$$

is the palm print image feature encoding vector. \vec{vₖ} is any base database feature. ID information associated with a base database feature having a highest similarity is used as ID information of the target object, and the ID information of the target object is returned to the terminal payment device as an identification result, to perform payment processing based on the identification result.

The foregoing palm print identification is used for payment processing. Compared with a facial identification technology, the palm print is more beneficial to protecting user privacy due to concealment, and is not affected by factors such as a mask, makeup, and sunglasses. Therefore, a palm print identification technology has a wide use prospect in commercial scenarios such as mobile payment and identity verification.

To verify effectiveness of the trained feature extraction network in this application, a data set of 1000 identities, each identity corresponding to 50 normal images and 50 difficult images, is used to verify a feature extraction network obtained through training by using the feature extraction network training method in this application and a feature extraction network obtained through training by using a training method in the existing method. A verification result is shown in Table 1.

| Quantity of samples | Normal | Difficult |
|---|---|---|
| with verification errors | data set | data set |
| Existing method | 57 | 94 |
| This application | 2 | 4 |

It can be learned from Table 1 that an error identification rate on the difficult data set is significantly higher than that on the normal data set according to the existing method, while the feature extraction network obtained through training by using the training method of this application can perform well on both the normal data set and the difficult data set. It can be learned that accuracy of identifying difficult palm print data can be improved by using the feature extraction network training method in this application.

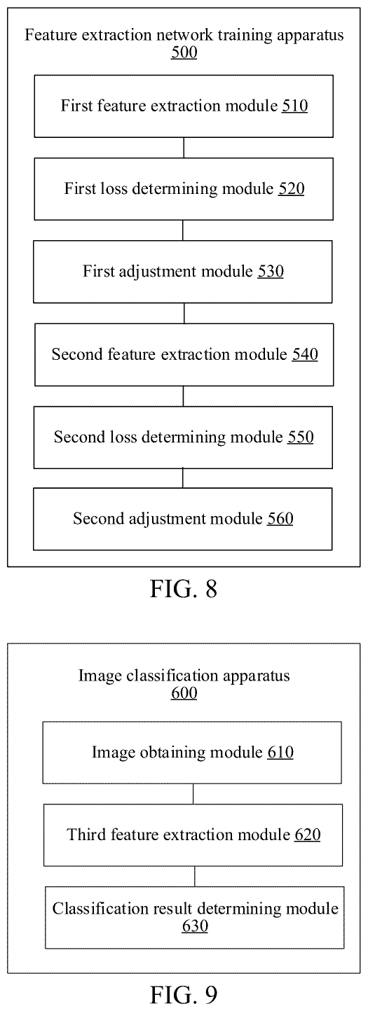

Refer to FIG. 8. Another embodiment of this application provides a feature extraction network training apparatus 500. The feature extraction network training apparatus 500 includes a first feature extraction module 510, a first loss determining module 520, a first adjustment module 530, a second feature extraction module 540, a second loss determining module 550, and a second adjustment module 560. The first feature extraction module 510 is configured to extract an image feature of a first sample image by using a to-be-trained feature extraction network. The first loss determining module 520 is configured to determine a first loss based on the image feature of the first sample image, a class label of the first sample image, and initial class center matrices respectively corresponding to a plurality of class centers of each of a plurality of classes. The first adjustment module 530 is configured to adjust, based on the first loss, a parameter of the to-be-trained feature extraction network and the initial class center matrices respectively corresponding to the plurality of class centers of each class, to obtain a preliminarily trained feature extraction network and first class center matrices respectively corresponding to the plurality of class centers of each class. The second feature extraction module 540 is configured to extract an image feature of a second sample image by using the preliminarily trained feature extraction network. The second loss determining module 550 is configured to determine a second loss based on the image feature of the second sample image, a class label of the second sample image, and a first class center matrix corresponding to a main class center of each class, a main class center of one class being one of a plurality of class centers of the class. The second adjustment module 560 is configured to adjust, based on the second loss, a parameter of the preliminarily trained feature extraction network and the first class center matrix corresponding to the main class center of each class, to obtain a trained feature extraction network. The trained feature extraction network may be configured for image classification.

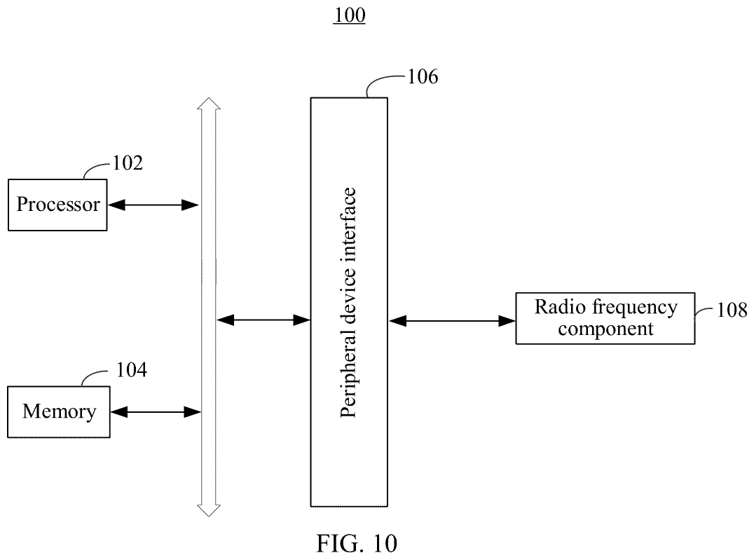

Refer to FIG. 9. An embodiment of this application provides an image classification apparatus 600. The image classification apparatus 600 includes an image obtaining module 610, a third feature extraction module 620, and a classification result determining module 630. The image obtaining module 610 is configured to obtain a to-be-classified image. The third feature extraction module 620 is configured to perform feature extraction on the to-be-classified image by using the trained feature extraction network obtained by using the foregoing feature extraction network training apparatus, to obtain a target image feature. The classification result determining module 630 is configured to determine a classification result of the to-be-classified image based on the target image feature.

All the modules in the apparatus may be partially or completely implemented through software, hardware, or any combination thereof. All the modules may be embedded in or independent of a processor in a computer device in a form of hardware, or may be stored in a memory in the computer device in a form of software, such that the processor may invoke and execute operations corresponding to the modules. The apparatus embodiments and the foregoing method embodiments in this application mutually correspond. For specific principles in the apparatus embodiments, refer to content in the foregoing method embodiments. Details are not described herein again.

The following describes an electronic device provided in this application with reference to FIG. 10.

Refer to FIG. 10. Based on the feature extraction network training method provided in the foregoing embodiments, an embodiment of this application further provides another electronic device 100 that includes a processor 102 that can perform the foregoing method. The electronic device 100 may be a server or a terminal device, and the terminal device may be a device, for example, a smartphone, a tablet computer, a computer, or a portable computer.

The electronic device 100 further includes a memory 104. The memory 104 stores a program that can execute content in the foregoing embodiments, and the processor 102 can execute the program stored in the memory 104.

The processor 102 may include one or more cores configured to process data and a message matrix unit. The processor 102 is connected to various parts of the entire electronic device 100 by using various interfaces and lines, and performs various functions of the electronic device 100 and processes data by running or executing instructions, a program, a code set or an instruction set stored in the memory 104 and invoking data stored in the memory 104. In some embodiments, the processor 102 may be implemented by using at least one hardware form of digital signal processing (DSP), a field-programmable gate array (FPGA), and a programmable logic array (PLA). The processor 102 may integrate one or a combination of a central processing unit (CPU), a graphics processing unit (GPU), a modem, and the like. The CPU mainly processes an operating system, a user interface, an application program, and the like. The GPU is responsible for rendering and drawing display content. The modem is configured to process wireless communication. The foregoing modem may not be integrated into the processor 102, but may be implemented independently through a communication chip.

The memory 104 may include a random access memory (RAM), or may include a read-only memory (ROM). The memory 104 may be configured to store the instructions, the program, code, the code set, or the instruction set. The memory 104 may include a program storage area and a data storage area. The program storage area may store an instruction for implementing an operating system, an instruction for implementing at least one function, an instruction for implementing the following method embodiments, and the like. The storage data area may further store data (for example, training data or a to-be-classified image) obtained based on use of the electronic device 100.

The electronic device 100 may further include a network module and a screen. The network module is configured to receive and send an electromagnetic wave, and implement mutual conversion between the electromagnetic wave and an electric signal, so as to communicate with a communication network or another device, for example, communicate with an audio playback device. The network module may include various existing circuit elements configured to perform these functions, such as an antenna, a radio frequency transceiver, a digital signal processor, a cipher/decipher chip, a subscriber identity module (SIM) card, and a memory. The network module may communicate with various networks such as the Internet, a corporate intranet, and a wireless network, or communicate with another device via a wireless network. The foregoing wireless network may include a cellular telephone network, a wireless local area network, or a metropolitan area network. The screen may display interface content and perform data exchange, for example, display a molecular property prediction result of to-be-identified audio and record the audio by using the screen.

In some embodiments, the electronic device 100 may alternatively include a peripheral device interface 106 and at least one peripheral device. The processor 102, the memory 104, and the peripheral device interface 106 may be connected through a bus or a signal line. Each peripheral device may be connected to the peripheral device interface through a bus, a signal line, or a circuit board. Specifically, the peripheral device includes a radio frequency component 108 and the like.

The peripheral device interface 106 may be configured to connect the at least one peripheral device related to input/output (I/O) to the processor 102 and the memory 104. In some embodiments, the processor 102, the memory 104, and the peripheral device interface 106 are integrated on a same chip or circuit board. In some other embodiments, any one or two of the processor 102, the memory 104, and the peripheral device interface 106 may be implemented on a single chip or circuit board. This is not limited in embodiments of this application.

The radio frequency component 108 is configured to receive and transmit a radio frequency (RF) signal, which is also referred to as an electromagnetic signal. The radio frequency component 108 communicates with a communication network and another communication device through the electromagnetic signal. The radio frequency component 108 converts an electric signal into an electromagnetic signal for transmission, or converts a received electromagnetic signal into an electric signal. In some embodiments, the radio frequency component 108 includes an antenna system, an RF transceiver, one or more amplifiers, a tuner, an oscillator, a digital signal processor, a codec chip set, a subscriber identity module card, and the like. The radio frequency component 108 may communicate with another terminal through at least one wireless communication protocol. The wireless communication protocol includes but is not limited to a world wide web, a metropolitan area network, an intranet, generations of mobile communication networks (2G, 3G, 4G, and 5G), a wireless local area network and/or a wireless fidelity (Wi-Fi) network. In some embodiments, the radio frequency component 108 may further include a circuit related to near field communication (NFC), which is not limited in this application.

An embodiment of this application further provides a block diagram of a structure of a computer-readable storage medium. The computer-readable medium stores program code, and the program code may be invoked by a processor to perform the method described in the foregoing method embodiments.

The computer-readable storage medium may be an electronic memory, for example, a flash memory, an electrically erasable programmable read-only memory (EEPROM), an erasable programmable read-only memory (EPROM), a hard disk, or a ROM. In some embodiments, the computer-readable storage medium includes a non-volatile computer-readable medium (non-transitory computer-readable storage medium). The computer-readable storage medium has storage space for program code for performing any method operation in the foregoing method. The program code may be read from or written into one or more computer program products. The program code may be, for example, compressed in a proper form.

An embodiment of this application further provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, to enable the computer device to perform the method described in the foregoing various implementations.

Finally, the foregoing embodiments are merely intended for describing the technical solutions of this application, but not for limiting this application. Although this application is described in detail with reference to the foregoing embodiments, a person of ordinary skill in the art is to understand that modifications may still be made to the technical solutions described in the foregoing embodiments or equivalent replacements may be made to some technical features thereof, as long as such modifications or replacements do not cause the essence of corresponding technical solutions to depart from the spirit and scope of the technical solutions of embodiments of this application.

What is claimed is:

1. A feature extraction network training method, performed by an electronic device, the method comprising:
performing the following operations in each iteration epoch of a first training stage:
extracting an image feature of a first sample image by using a to-be-trained feature extraction network;
determining a first loss based on the image feature of the first sample image, a class label of the first sample image, and initial class center matrices respectively corresponding to a plurality of class centers of each of a plurality of classes;
adjusting, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class; and
performing the following operations in each iteration epoch of a second training stage:
extracting an image feature of a second sample image by using the preliminarily trained feature extraction network;
determining a second loss based on the image feature of the second sample image, a class label of the second sample image, and a first class center matrix corresponding to a main class center of each class, a main class center of one class being one of a plurality of class centers of the class; and
adjusting, based on the second loss, a parameter of the preliminarily trained feature extraction network and the first class center matrix corresponding to the main class center of each class, until a second training stage ending condition is met, to obtain a trained feature extraction network, the trained feature extraction network being configured for image classification.

2. The method according to claim 1, wherein determining the first loss based on the image feature of the first sample image, the class label of the first sample image, and the initial class center matrices respectively corresponding to the plurality of class centers of each of the plurality of classes comprises:
calculating, for each class, first similarities between the image feature of the first sample image and the initial class center matrices respectively corresponding to the plurality of class centers of the class; and
determining the first loss based on the first similarities between the image feature of the first sample image and the initial class center matrices respectively corresponding to the plurality of class centers of each class.

3. The method according to claim 2, wherein determining the first loss based on the first similarities between the image feature of the first sample image and the initial class center matrices respectively corresponding to the plurality of class centers of each class comprises:
determining an initial class center matrix that is of the initial class center matrices of each class and that has a largest first similarity with the image feature of the first sample image as a first reference class center matrix;
determining a first sub-loss based on the first reference class center matrix and the class label of the first sample image;
determining, for each class, an initial class center matrix that is in a plurality of initial class center matrices of the class and that has a largest first similarity with the image feature of the first sample image as a second reference class center matrix of the class;
determining a second sub-loss based on a first similarity between a second reference class center matrix of each of the plurality of classes and the image feature of the first sample image; and
determining the first loss based on the first sub-loss and the second sub-loss.

4. The method according to claim 3, wherein determining the first loss based on the first sub-loss and the second sub-loss comprises:
determining a first interval parameter and a first scaling coefficient based on a first quantity of epochs corresponding to an iteration epoch that the first sample image participates in, the first interval parameter and the first scaling coefficient being negatively correlated to the first quantity of epochs; and
calculating an additive angular interval loss based on the first interval parameter, the first scaling coefficient, the first sub-loss, and the second sub-loss, to obtain the first loss.

5. The method according to claim 4, wherein determining the first interval parameter and the first scaling coefficient based on the first quantity of epochs corresponding to the iteration epoch that the first sample image participates in comprises:
determining a first coefficient based on the first quantity of epochs corresponding to the iteration epoch that the first sample image participates in, the first coefficient being negatively correlated to the first quantity of epochs;
determining a first interval adjustment value based on the first coefficient, and adding the first interval adjustment value and a first reference interval parameter, to obtain the first interval parameter; and
determining a first scaling adjustment value based on the first coefficient, and adding the first scaling adjustment value and a first reference scaling coefficient, to obtain the first scaling coefficient.

6. The method according to claim 1, wherein there are a plurality of first sample images, and before determining the second loss based on the image feature of the second sample image, the class label of the second sample image, and the first class center matrix corresponding to the main class center of each class, the method further comprises:
determining a reference image set corresponding to each class, a reference image set corresponding to one class comprising a plurality of first sample images having a class label the same as that of the class;
determining, for each class based on a similarity between an initial class center matrix of each class center of the class and an image feature of each first sample image in the reference image set corresponding to the class, a reference similarity corresponding to the class center of the class; and
determining, for each class, a class center having a largest reference similarity of the class as a main class center of the class.

7. The method according to claim 1, wherein there are a plurality of second sample images, and determining the second loss based on the image feature of the second sample image, the class label of the second sample image, and the first class center matrix corresponding to the main class center of each class comprises:
performing similarity calculation on the image feature of each second sample image and the first class center matrix corresponding to the main class center of each class, to obtain a second similarity between the image feature of each second sample image and the main class center of each class;
using a class to which a main class center having a largest second similarity with the image feature of the second sample image belongs in the plurality of classes as a predicted class of the second sample image; and
determining the second loss based on the class label of the second sample image and the predicted class of the second sample image.

8. The method according to claim 7, wherein determining the second loss based on the class label of the second sample image and the predicted class of the second sample image comprises:
determining a second interval parameter and a second scaling coefficient based on a second quantity of epochs corresponding to an iteration epoch that the second sample image participates in, the second interval parameter and the second scaling coefficient being negatively correlated to the second quantity of epochs; and
calculating an additive angular interval loss based on the second interval parameter, the second scaling coefficient, the class label of the second sample image, and the predicted class of the second sample image, to obtain the second loss.

9. The method according to claim 8, wherein determining the second interval parameter and the second scaling coefficient based on the second quantity of epochs corresponding to the iteration epoch that the second sample image participates in comprises:
determining a second coefficient based on the second quantity of epochs corresponding to the iteration epoch that the second sample image participates in, the second coefficient being negatively correlated to the second quantity of epochs;
determining a second interval adjustment value based on the second coefficient, and adding a second reference interval parameter and the second interval adjustment value, to obtain the second interval parameter; and
determining a second scaling adjustment value based on the second coefficient, and adding a second reference scaling coefficient and the second scaling adjustment value, to obtain the second scaling coefficient.

10. A feature extraction network training apparatus, wherein the apparatus has a memory configured to store computer-readable instructions and a processor configured to execute the instructions to carry out the method of claim 1.

11. A computer program product, the computer program product comprising computer instructions, the computer instructions being stored in a computer-readable storage medium, and the computer instructions cause a computer to execute the method of claim 1.

12. An image classification method, performed by an electronic device, the method comprising:
obtaining a to-be-classified image;
performing feature extraction, to obtain a target image feature, on the to-be-classified image by using a trained feature extraction network; and
determining a classification result of the to-be-classified image based on the target image feature,
wherein the trained feature extraction network is trained by:
performing the following operations in each iteration epoch of a first training stage:
extracting an image feature of a first sample image by using a to-be-trained feature extraction network;
determining a first loss based on the image feature of the first sample image, a class label of the first sample image, and initial class center matrices respectively corresponding to a plurality of class centers of each of a plurality of classes;
adjusting, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class; and
performing the following operations in each iteration epoch of a second training stage:
extracting an image feature of a second sample image by using the preliminarily trained feature extraction network;
determining a second loss based on the image feature of the second sample image, a class label of the second sample image, and a first class center matrix corresponding to a main class center of each class, a main class center of one class being one of a plurality of class centers of the class; and
adjusting, based on the second loss, a parameter of the preliminarily trained feature extraction network and the first class center matrix corresponding to the main class center of each class, until a second training stage ending condition is met, to obtain a trained feature extraction network, the trained feature extraction network being configured for image classification.

13. The method according to claim 12, wherein the classification result of the to-be-classified image comprises an authentication result; and
determining the classification result of the to-be-classified image based on the target image feature comprises:
performing similarity calculation on the target image feature and a plurality of reference image features in a preset database, to obtain similarities between the target image feature and the reference image features;
determining, based on the similarities between the target image feature and the reference image features, a target reference image feature having a largest similarity with the target image feature; and
using authentication information associated with the target reference image feature as the authentication result of the to-be-classified image.

14. The method according to claim 13, wherein after using authentication information associated with the target reference image feature as the authentication result of the to-be-classified image, the method further comprises:
performing payment processing based on the authentication result of the to-be-classified image.

15. The method according to claim 12, wherein the to-be-classified image is a palm print image, and obtaining the to-be-classified image comprises:
obtaining a hand image;
performing key point detection on the hand image, to obtain a finger gap key point in the hand image; and
clipping a palm print pixel area from the hand image as the palm print image based on the finger gap key point in the hand image.

16. An image classification apparatus, wherein the apparatus has a memory configured to store computer-readable instructions and a processor configured to execute the instructions to carry out the method of claim 12.

17. A non-transitory computer-readable storage medium, the computer-readable storage medium having program code stored therein, and the program code being capable of being executed by a processor to:
obtain a to-be-classified image;
perform feature extraction, to obtain a target image feature, on the to-be-classified image by using a trained feature extraction network; and
determine a classification result of the to-be-classified image based on the target image feature,
wherein the trained feature extraction network is trained by:
performing the following operations in each iteration epoch of a first training stage:
extracting an image feature of a first sample image by using a to-be-trained feature extraction network;
determining a first loss based on the image feature of the first sample image, a class label of the first sample image, and initial class center matrices respectively corresponding to a plurality of class centers of each of a plurality of classes;
adjusting, based on the first loss, a parameter of the to-be-trained feature extraction network and the initial class center matrices respectively corresponding to the plurality of class centers of each class, until a first training stage ending condition is met, to obtain a preliminarily trained feature extraction network and first class center matrices respectively corresponding to the plurality of class centers of each class; and
performing the following operations in each iteration epoch of a second training stage:
extracting an image feature of a second sample image by using the preliminarily trained feature extraction network;
determining a second loss based on the image feature of the second sample image, a class label of the second sample image, and a first class center matrix corresponding to a main class center of each class, a main class center of one class being one of a plurality of class centers of the class; and
adjusting, based on the second loss, a parameter of the preliminarily trained feature extraction network and the first class center matrix corresponding to the main class center of each class, until a second training stage ending condition is met, to obtain a trained feature extraction network, the trained feature extraction network being configured for image classification.

18. The non-transitory computer-readable storage medium according to claim 17, wherein the classification result of the to-be-classified image comprises an authentication result; and
when executing the program code to determine the classification result of the to-be-classified image based on the target image feature comprises, the processor is further configured to:
perform similarity calculation on the target image feature and a plurality of reference image features in a preset database, to obtain similarities between the target image feature and the reference image features;
determine, based on the similarities between the target image feature and the reference image features, a target reference image feature having a largest similarity with the target image feature; and
use authentication information associated with the target reference image feature as the authentication result of the to-be-classified image.

19. The non-transitory computer-readable storage medium according to claim 18, wherein after use of the authentication information associated with the target reference image feature as the authentication result of the to-be-classified image, the processor is further configured to:
perform payment processing based on the authentication result of the to-be-classified image.

20. The non-transitory computer-readable storage medium according to claim 17, wherein the to-be-classified image is a palm print image, and to obtain the to-be-classified image when executing the program code the processor is further configured to:
obtain a hand image;
perform key point detection on the hand image, to obtain a finger gap key point in the hand image; and
clip a palm print pixel area from the hand image as the palm print image based on the finger gap key point in the hand image.
